(19) United States
(12) Patent Application Publication
(10) Pub. No.: US 2007/0053126 A1
(43) Pub. Date: Mar. 8, 2007

(54) Power supply equipped with an independent overload protection mechanism

(75) Inventor: Ching-Lin Chou, Taipei Hsien (TW)

Correspondence Address: BIRCH STEWART KOLASCH & BIRCH, PO BOX 747, FALLS CHURCH, VA, 22040-0747, US

(73) Assignee: TOPOWER COMPUTER INDUSTRIAL CO., LTD.

(21) Appl. No.: 11/217,368

(22) Filed: Sep. 2, 2005

(51) Int. Cl. H02H 3/08

(52) U.S. Cl. 361/93.1

(57) ABSTRACT

A power supply equipped with an independent overload protection mechanism includes a transformation circuit which consists of a plurality of transformers for transforming AC power to DC power. Each transformer has a front end connecting to a power switch. All the power switches are connected to a pulse-width modulation (PWM) controller. Each power switch and the PWM controller are bridged by a switch circuit which is electrically connected to a protection circuit to monitor whether an electronic device is overloaded. In the overload condition, the protection circuit outputs a protection signal to the switch circuit to stop or suspend the DC power cord from delivering electric power to drive the electronic device at the rear end. Hence an independent overload protection can be achieved.

### FIELD OF THE INVENTION

The present invention relates to a power supply equipped with an independent overload protection mechanism and particularly to a power supply equipped with an overload protection mechanism adopted for use on electronic devices to provide independent monitoring of individual electronic device operation conditions and individually offer an overload protection mechanism.

### BACKGROUND OF THE INVENTION

These days, user's demand for more powerful computer systems grows constantly. Power supply requirements of CPU and peripherals also increase. The power supply used in the computer system also has to provide a greater power output. However, due to the concern of the possible harmful effect to human body, there is an energy limitation for the output power of power supply (maximum output power (Max VA) specification at present is mostly 240 VA. For example, with output of 12V, the maximum output current is 20 A). For instance, in SSI or UL standards, there is an Energy Hazard standard for the power supply of electric equipment. The maximum output power of the power supply is 240 VA to protect the safety of the general computer users.

Refer to FIG. 1 for the overload protection technique now adopted by the conventional power supply. The power supply receives AC power 10 and has commutation filter circuits 21 and 22 and a transformer 31 to transform the AC power to a plurality of DC power to drive at least one electronic device 81. The transformer 31 outputs DC power of different voltage levels according to different coil number ratios on the secondary side. There are a power switch 41 and a pulse-width modulation (PWM) controller 60 connected to a transformer driving signal source on the front side of the transformer 31. The protection mechanism includes capturing a power use value on the DC power cord input to the electronic device 81 and sending the power use value to a protection circuit 71. The protection circuit 71 provides a preset over-voltage protection value in a constant current or constant voltage mode to be compared with the power use value. If the power use value is greater than the over-voltage protection value, the protection circuit 71 outputs the comparison value to the power switch 41 or PWM controller 60 to stop or suspend power output on the DC power cord that drives the electronic device 81 at the rear end. Thus the object of the overload protection mechanism in the power supply is achieved.

However, nowadays the operation speed of computer system increases very fast, and the number of electronic devices connected to the computer system also increases constantly, overload condition could happen to one of the electronic devices. In such an occasion, the power supply immediately stops all power output. If the overloaded electronic device is a storage device or other peripheral (such as a backup hard disk or optical disk drive), operation of the computer system does not have to be stopped immediately. Moreover, when the power supply stops power output and causes shutdown of the computer system, users do not know which electronic device is overloaded. It is troublesome for users that they have to send the entire computer system for repairs.

### SUMMARY OF THE INVENTION

Therefore the primary object of the present invention is to solve the aforesaid disadvantages. The invention provides a power supply that has an improved transformation circuit which consists of a plurality of transformers to transform AC power to DC power. Each transformer is connected to a power switch on the front end that is coupled with a PWM controller. The individual power switch and the PWM controller are bridged by a switch circuit which is electrically connected to a protection circuit which monitors whether an electronic device is in an overload operation condition. If an overload condition occurs, the protection circuit outputs a protection signal to the switch circuit to stop or suspend the DC power cord from delivering electric power to the electronic device at the rear end. Thus the power supply has an independent overload protection mechanism.

Another object of the invention is to connect the switch circuit to an alert unit such as an indication light set to enable users to clearly determine which electronic device is overloaded. Therefore the overloaded device can be replaced without sending the entire computer system for repairs.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a circuit block diagram of a conventional power supply.

FIGS. 2 and 3 are circuit block diagrams of a first embodiment of the present invention.

FIG. 4 is a circuit block diagram of a second embodiment of the present invention.

FIG. 5 is a circuit block diagram of a third embodiment of the present invention.

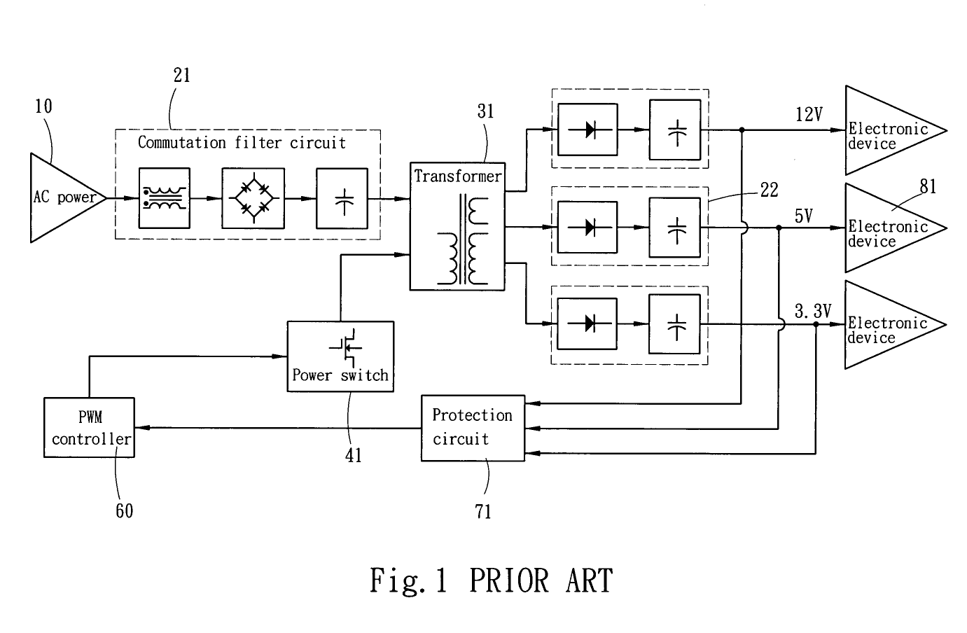

### DETAILED DESCRIPTION OF THE PREFERRED

### EMBODIMENTS

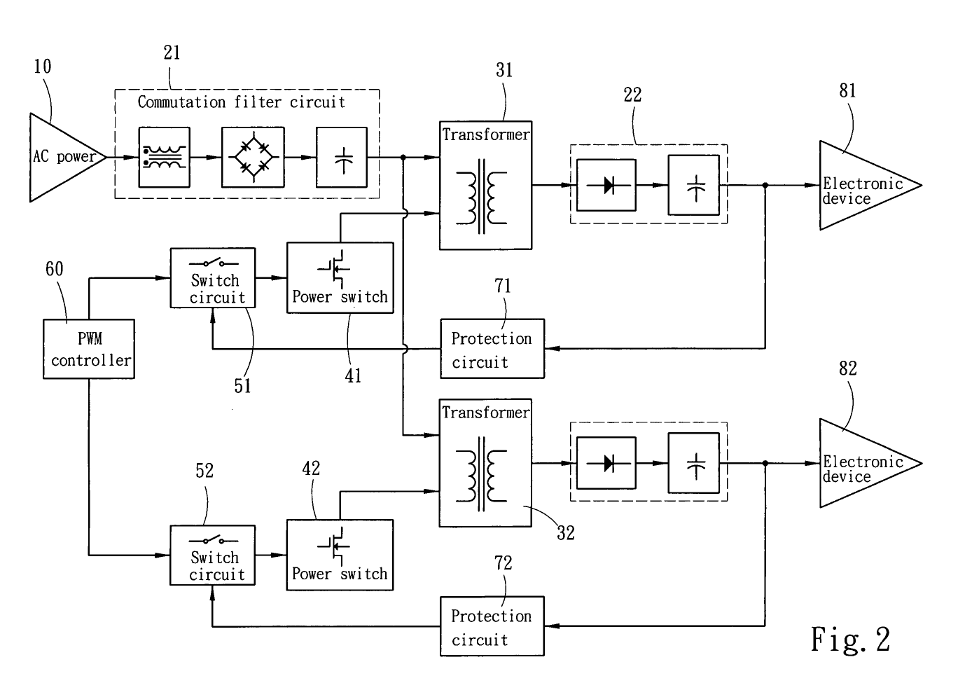

Please refer to FIG. 2 for the circuit block diagram of a first embodiment of the invention. The power supply equipped with an independent overload protection mechanism of the invention aims to receive an AC power 10 to pass through commutation filter circuits 21 and 22 and a transformation circuit to become a plurality of DC power to drive at least one electronic device 81, 82 at the rear end. The DC power cords input to the electronic devices 81 and 82 have a power use value captured and sent respectively to protection circuits 71 and 72. The transformation circuit of the power supply consists of two or more transformers 31 and 32 that are connected respectively at the front end to a power switch 41, 42. All the power switches 41 and 42 are connected to a PWM controller 60. The transformers 31 and 32 and the PWM controller 60 are bridged respectively by a switch circuit 51, 52 which is electrically connected to the protection circuit 71, 72. Hence the protection circuits 71 and 72 can receive the power use value and determine whether an overload condition exists, and output a protection signal to the switch circuit 51, 52 if the overload condition exists to stop or suspend the DC power cord from outputting power to drive the electronic device 81, 82 at the rear end.

The commutation filter circuit circuits 21 and 22 include the commutation filter circuit 21 on the first side of the transformers 31 and 32, and the commutation filter circuit 22 on the second side of the transformers 31 and 32. Depending on the power delivery condition of the power supply, the transformers 31 and 32 can be connected individually to the commutation filter circuit circuits 21 and 22, or jointly share the commutation filter circuit circuits 21 and 22. The switch circuits 51 and 52 can be integrated to a signal distributor to receive a driving signal output from the PWM controller 60, and divide the driving signal into a plurality of sub-driving signals that have the same phase and same frequency to be sent to the power switches 41 and 42. The signal distributor can be a multiplex linear switch, relay or microprocessor. Similarly, the protection circuits 71 and 72 may also be integrated into a single microprocessor.

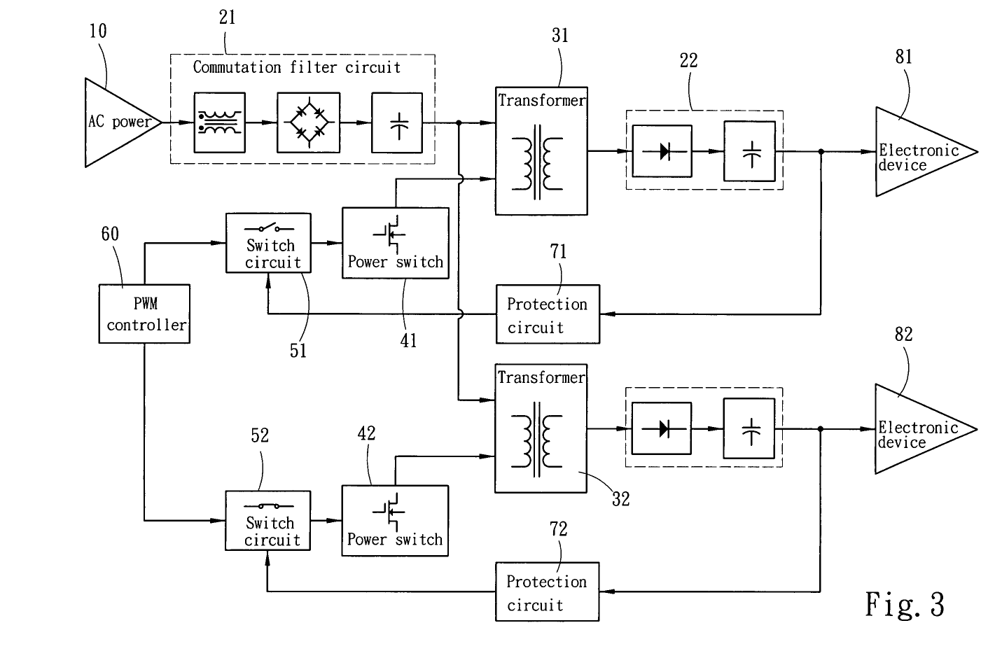

Referring to FIG. 3, in the power supply of the invention that has an independent overload protection mechanism, a power use value is captured from the DC power cords connecting to the electronic devices 81 and 82 to be sent to the protection circuits 71 and 72. The protection circuits 71 and 72 compare the captured power use value with a preset over-voltage protection value. In the event that the electronic device 81 is overloaded, the switch circuit 51 receives a protection signal output from the protection circuit 71 to become an open condition. Hence the driving power of the electronic device 81 is stopped. As another DC power cord is not overloaded, the switch circuit 52 remains in a closed condition, and the driving power is continuously supplied to the electronic device 82. Namely, the power supply only suspends the power to the electronic device 81 which is overloaded, while power supply to the electronic device 82 which is not overloaded remains normal. Hence the computer system does not have to be completely shut down.

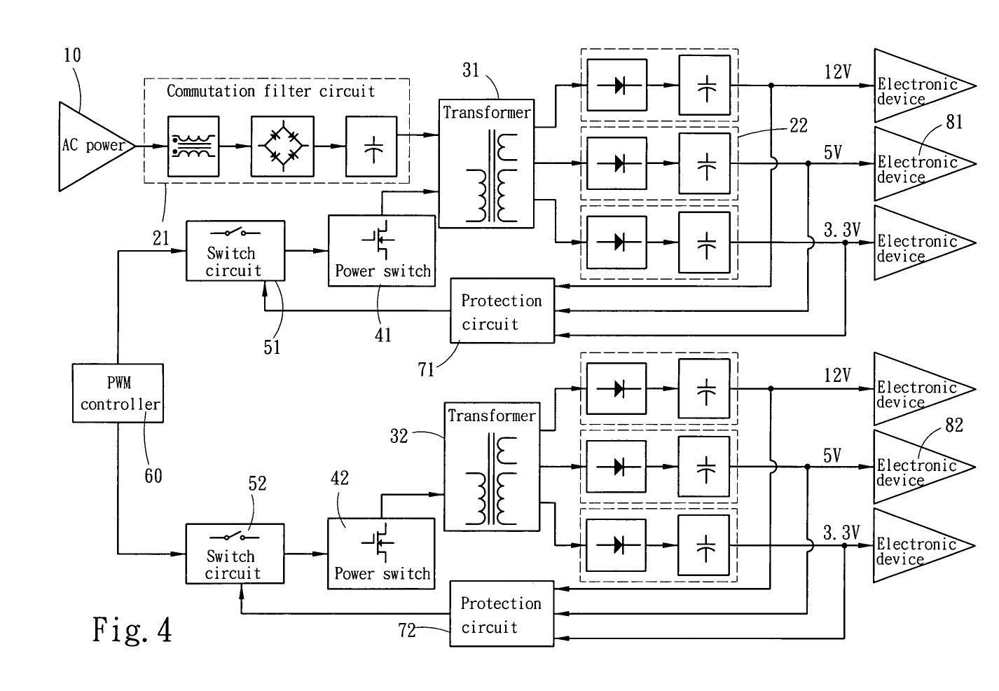

Refer to FIG. 4 for the circuit block diagram of a second embodiment of the invention. It differs from the embodiment shown in FIG. 2 by dividing the output DC power of the transformers 31 and 32 into multiple sets of different voltage levels. According to the present techniques, the DC voltage includes 3.3V, 5V and 12V. All the DC power can be included in the protection mechanism, or only the DC power of 12V is included in the protection mechanism.

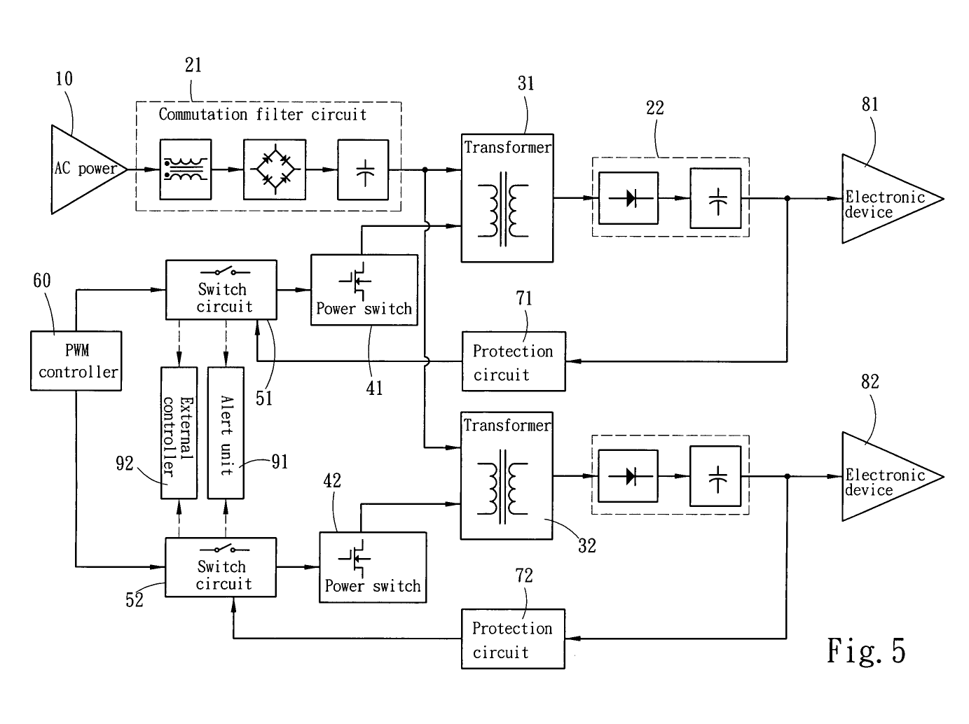

Refer to FIG. 5 for the circuit block diagram of a third embodiment of the invention. Based on the embodiment shown in FIG. 2, an external controller 91 is added to regulate ON/OFF level of the switch circuits 51 and 52. Or in the event that the protection circuits 71 and 72 malfunction, and the electronic devices 81 and 82 are overloaded, the external controller 91 can immediately turn off the switch circuits 51 and 52. In addition, the switch circuits 51 and 52 may further be connected to an alert unit 92 which has a LED indication light. In the event that the electronic devices 81 and 82 are overloaded, the switch circuits 51 and 52 are operated to activate the alert unit 92. Thereby users can be informed which of the electronic devices 81 and 82 is in the overload condition and can take immediate inspection and do replacement more effectively.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A power supply equipped with an independent overload protection mechanism to receive an AC power which passes through an internal commutation filter circuit and a transformation circuit to become a plurality of DC powers to drive at least one electronic device at a rear end, comprising a protection circuit to receive a power use value captured from a DC power cord input to the electronic device,
wherein the transformation circuit includes at least two transformers each having a front end connecting to a power switch, the power switch being connected to a pulse-width modulation (PWM) controller, each transformer and the PWM controller being electrically connected to a switch circuit in the protection circuit, the protection circuit receiving the power use value and determining an overload condition to output a protection signal to the switch circuit to stop or suspend the DC power cord from outputting power to drive the electronic device at the rear end.

2. The power supply equipped with an independent overload protection mechanism of claim 1, wherein the switch circuits are integrated to a signal distributor which receives a driving signal output from the PWM controller and divides the driving signal into a plurality of sub-driving signals that have a same phase and a same frequency to be sent to the power switches.

3. The power supply equipped with an independent overload protection mechanism of claim 2, wherein the signal distributor is one selected from the group consisting of a multiplex linear switch, a relay and a microprocessor.

4. The power supply equipped with an independent overload protection mechanism of claim 1, wherein the protection circuits are integrated into a single microprocessor.

5. The power supply equipped with an independent overload protection mechanism of claim 1, wherein the switch circuit is connected to an external controller.

6. The power supply equipped with an independent overload protection mechanism of claim 1, wherein the switch circuit is connected to an alert unit.

7. The power supply equipped with an independent overload protection mechanism of claim 1, wherein the DC power output from the transformer is divided into multiple sets of different voltage levels.
